(19) United States
(12) Patent Application Publication
(10) Pub. No.: US 2007/0291012 A1
(43) Pub. Date: Dec. 20, 2007

(54) Scanning control device for a capacitive touch panel

(76) Inventor: Chin-Fu Chang, Sijhih City (TW)

Correspondence Address: HERSHKOVITZ & ASSOCIATES, 2845 DUKE STREET, ALEXANDRIA, VA, 22314, US

(21) Appl. No.: 11/519,094

(22) Filed: Sep. 12, 2006

(30) Foreign Application Priority Data
Jun. 20, 2006 (TW) 095122033

(51) Int. Cl. G06F 3/041

(52) U.S. Cl. 345/173

(57) ABSTRACT

A scanning control device for a capacitive touch panel uses voltage driving/current detecting circuits to connect to a top conductive layer of the touch panel. Output terminals of all voltage driving/current detecting units are connected to a signal processing unit through a switching unit. Output data of the signal processing unit are output to a central control unit. If the touch panel is pressed, all voltage driving/current detecting circuits detect current values at four corners of the top conductive layer and sequentially output the current values to the signal processing unit. The processed data output from the signal processing unit are transmitted to the central control unit. Based on the received data, the central control unit calculates coordinate of a pressed point on the touch panel.

### BACKGROUND OF THE INVENTION

1. Field of the Invention

The present invention relates to a scanning control device for a capacitive touch panel, and more particularly to a scanning control device that can sequentially receive current signals at each corner of the touch panel by scanning.

2. Description of Related Art

Most people often uses electronic devices equipped with a touch-controlled display in their daily lives, for example an automated teller machine or a copy machine. By slightly touching icons shown on the display, a user can easily operate the desired functions. The touch-controlled operation is provided by a transparent touch panel mounted on the surface of the display. The touch panels can be categorized to resistive type, capacitive type and surface wave type. When putting a finger on the resistive touch panel, a voltage signal occurs for calculating coordinate information of the touch point. For the capacitive touch panel, the coordinate information is obtained based on variations of electrical currents since a user's finger can absorb a minor current when touching the panel. For the surface wave type touch panel, the user's finger will interfere acoustic wave or infrared wave covering the entire surface of the touch panel when touching the panel. Therefore, the coordinate information of the touching point can be calculated.

With reference to FIG. 5, the capacitive touch panel includes a transparent substrate (80) with flat surfaces, a top conductive layer (81) and a bottom conductive layer (82) respectively formed on the surfaces of the substrate (80), and isolating layers (83)(84) respectively formed on an outer surface of the top conductive layer (81) and the bottom conductive layer (82).

Alternating current signals with a constant voltage amplitude are respectively input to four corners of the top conductive layer (81). The bottom conductive layer (82) can be connected to a constant DC voltage or a ground. If the AC signal is V=V₀ sin(wt), the respective detected current at positions A and B can be expressed as:

I_{A}=Ias₀ sin(wt+φ 1)

I_{B}=Ibs₀ sin(wt+φ 1)

When any conductive object touches the panel at the point P, the voltage level at the touching point immediately has a change. Further, the electric field and current distribution over the top conductive layer (81) also accordingly change. Changes of the current values and phases also can be detected at each corner. The coordinate of the touching point P is thus obtained based on the quantities of the current change. If the current variations at the four corner of the top conductive layer (81) are ΔI₁, ΔI₂, ΔI₃ and ΔI₄ respectively, the total current absorbed by human body can be regarded as a summation of ΔI₁, ΔI₂, ΔI₃ and ΔI₄ when the user who touches the panel has a relative large resistance. The coordinate of the touching point is expressed by components x and y:

$$x = \frac{( Δ {I}_{1} + Δ {I}_{2} ) - ( Δ {I}_{3} + Δ {I}_{4} )}{{\sum }_{i = 1}^{4} Δ {I}_{i}}$$

$$y = \frac{( Δ {I}_{1} + Δ {I}_{3} ) - ( Δ {I}_{2} + Δ {I}_{4} )}{{\sum }_{i = 1}^{4} Δ {I}_{i}}$$

With reference to FIG. 9, a conventional coordinate calculating circuit for the foregoing capacitive touch panel comprises multiple voltage driving and current detecting units (61)-(64), a central control unit (60) and multiple signal processing units (71)-(74).

The voltage driving and current detecting units (61)-(64) respectively connect to the four corners of the top conductive layer (81) to detect current variations at each corner.

The central control unit (60) is used as a control and data calculation element. The output data of the central control unit (60) is transmitted to a host of the electronic device equipped with the touch panel.

Each of the signal processing units (71)-(74) is composed of a filtering circuit, a sampling circuit, an integrating amplifier and an A/D converter. The detected current signal is sequentially processed by the filtering circuit, the sampling circuit and the integrating amplifier. Eventually the current signal becomes digital data to be transmitted to the central control unit (60) for coordinate calculation.

In the coordinate calculating circuit, the detected current signals at the corners of the top conductive layer (81) are processed by the respective signal processing unit (71)-(74). However, the coordinate calculating circuit causes problems as follows.

1. The signal processing units (71)-(74) may have different gain values and sampling signals. Although the signal processing units (71)-(74) are composed of the same circuits, electronic elements in these circuits still have different electronic characteristics. For example, the gain values and phases of the sampling signals of the signal processing units (71)-(74) are not the same. When considering these problems the foregoing coordinate calculation equations should be modified to

$$x = \frac{( {K}_{1} Δ {I}_{1} + {K}_{2} Δ {I}_{2} ) - ( {K}_{3} Δ {I}_{3} + {K}_{4} Δ {I}_{4} )}{{\sum }_{i = 1}^{4} {K}_{i} Δ {I}_{i}} and$$

$$y = \frac{( {K}_{1} Δ {I}_{1} + {K}_{3} Δ {I}_{3} ) - ( {K}_{2} Δ {I}_{2} + {K}_{4} Δ {I}_{4} )}{{\sum }_{i = 1}^{4} {K}_{i} Δ {I}_{i}}$$

To compensate the errors existed in the signal processing units (71)-(74), the increasing in the calculation complexity of the central control unit (60) is unavoidable.

2. Either the larger number of the electronic components or the high complexity of circuit design causes an expensive manufacturing cost.

### SUMMARY OF THE INVENTION

The main objective of the present invention is to provide a scanning control device for a capacitive touch panel that uses single signal processing unit to receive and process detected current signals on the touch panel. Therefore all detected current signals can be amplified with the same gain and sampled with the same sampling frequency. Coordinate calculation errors resulting from use of multiple signal processing units accordingly are solved.

To achieve the main objective, the scanning control device uses an alternate current (AC) signal producing unit, multiple voltage driving/current detecting units, a switching unit, a signal processing unit and a central control unit.

The AC signal processing unit generates an AC signal with a constant voltage amplitude and output the AC signal to the voltage driving/current detecting units that are connected to corners of a top conductive layer of the touch panel. The switching unit is connected between the multiple voltage driving/current detecting units and the signal processing unit to sequentially output the current values of the multiple voltage driving/current detecting units. The signal processing unit connects to the switching unit to receive and process the current values output from the switching unit. The central control unit connects to the AC signal producing unit, the switching unit and the signal processing unit to receive output data of the signal processing unit and calculate coordinate of a pressed point on the touch panel based on the data.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a first embodiment of a scanning control device for a capacitive touch panel in accordance with the present invention;

FIG. 2 is a circuit diagram of multiple voltage driving/current detecting units and a switching unit in accordance with the present invention;

FIG. 3 is a block diagram of a second embodiment of a scanning control device for a capacitive touch panel in accordance with the present invention;

FIGS. 4A-4B show a circuit diagram of voltage driving/current detecting units and a compensating circuit in accordance with the present invention;

FIG. 5 is a side view of a conventional capacitive touch panel;

FIG. 6 is a side view of the conventional capacitive touch panel with electrical currents Ia and Ib;

FIG. 7 is a side view of the conventional capacitive touch panel being pressed;

FIG. 8 is an equivalent model of a capacitive touch panel; and

FIG. 9 is a block diagram of a conventional coordinate calculating circuit for a capacitive touch panel.

### DETAILED DESCRIPTION OF THE PREFERRED EMBODIMENT

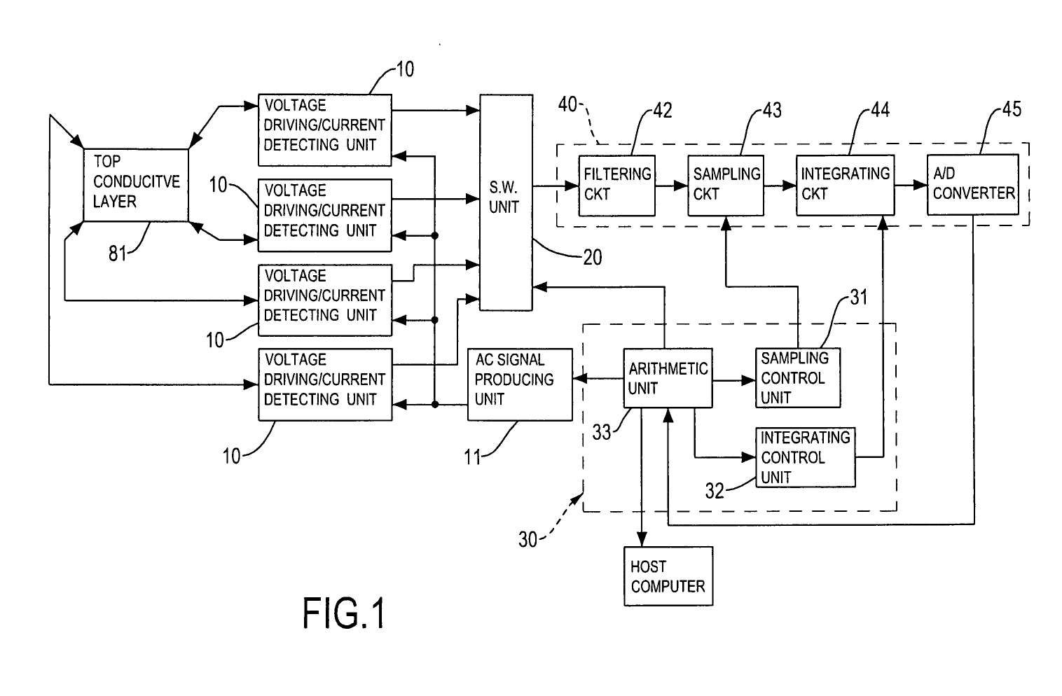

With reference to FIG. 1, a scanning control device for a capacitive touch panel comprises multiple voltage driving/current detecting units (10), a switching unit (20), a central control unit (30), a signal processing unit (40) and a AC signal producing unit (11).

The voltage driving/current detecting units (10) respectively connect to four corners of a top conductive layer (81) of the capacitive touch panel. All voltage driving/current detecting units (10) are connected to the signal processing unit (40) through the switching unit (20).

The central control unit (30) as a data calculation and control core comprises a sampling control unit (31) to control sampling frequency and time, an integrating control unit (32) to control a gain of the integrating amplifier (44), and an arithmetic unit (33). The arithmetic unit (33) has an output terminal connected to the switching unit (20).

The signal processing unit (40) is composed of a filtering circuit (42) connected to the output of the switching unit (20), a sampling circuit (43), an integrating amplifier (44) and an analog to digital (A/D) converting circuit (45). The sampling circuit (43) is connected between the output of the filtering circuit (42) and the input of the integrating amplifier (44), and is controlled by the sampling control circuit (31). The integrating amplifier (44) is connected to and controlled by the integrating control unit (32).

The AC signal producing unit (11) connects to all voltage driving/current detecting units (10), and is controlled by the arithmetic unit (33) of the central control unit (30). The AC signal producing unit (11) generates a AC signal with a constant voltage amplitude to be transmitted to the corners of the top conductive layer (81) through the voltage driving/current detecting units (10).

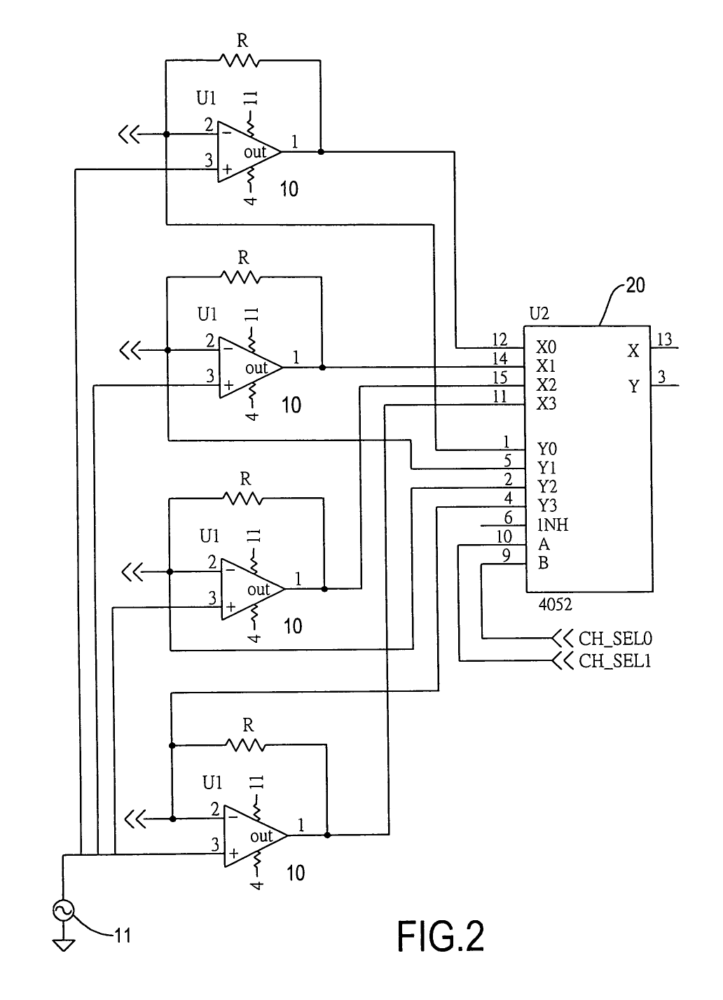

With reference to FIG. 2, each voltage driving/current detecting unit (10) is formed by an operational amplifier (U1) with a positive input terminal connected to the AC signal producing unit (11). The negative input terminal of the operational amplifier is connected to the output terminal through a feedback resistor (R) to form a feedback loop. The current value at each corner of the top conductive layer (81) is measured using the feedback resistor (R), wherein the detected current value is output to the switching unit (20).

The switching unit (20) is formed by a multiplexer in this embodiment, has multiple input terminals (X0-X3, Y0-Y3) and a set of output terminals (X, Y). The input terminals (X0-X3, Y0-Y3) are connected to the respective voltage driving/current detecting unit (10). The output terminals (X, Y) are connected to the signal processing unit (40).

When the scanning control circuit operates, each voltage driving/current detecting unit (10) detects the current value at a corner of the top conductive layer (81). Under control the central control unit (30), the switching unit (20) sequentially selects one of the voltage driving/current detecting unit (10) to be connected to the signal processing unit (40). Therefore, the current value of the selected voltage driving/current detecting unit (10) is filtered, sampled, amplified and eventually converted to digital data. The digital data is input to the central control unit (30) for coordinate calculation. Because all detected current values of the top conductive film (81) use the same signal processing unit (40), the signal processing unit (40) can apply the same gain value and sampling results on the detected current values, as a result, the processing errors due to separate circuits are eliminated.

As discussed above, when the current values are processed by separate signal processing units (40), the coordinate calculation equations should be modified as

$$x = \frac{( {K}_{1} Δ {I}_{1} + {K}_{2} Δ {I}_{2} ) - ( {K}_{3} Δ {I}_{3} + {K}_{4} Δ {I}_{4} )}{{\sum }_{i = 1}^{4} {K}_{i} Δ {I}_{i}} and$$

$$y = \frac{( {K}_{1} Δ {I}_{1} + {K}_{3} Δ {I}_{3} ) - ( {K}_{2} Δ {I}_{2} + {K}_{4} Δ {I}_{4} )}{{\sum }_{i = 1}^{4} {K}_{i} Δ {I}_{i}} .$$

Since the present invention uses a single signal processing unit (40) to sequentially scan and process the detected current values, K1, K2, K3, and K4 in the foregoing equations are the same. Therefore, the two equations are rewritten as

$$x = \frac{( Δ {I}_{1} + Δ {I}_{2} ) - ( Δ {I}_{3} + Δ {I}_{4} )}{{\sum }_{i = 1}^{4} Δ {I}_{i}}$$

$$y = \frac{( Δ {I}_{1} + Δ {I}_{3} ) - ( Δ {I}_{2} + Δ {I}_{4} )}{{\sum }_{i = 1}^{4} Δ {I}_{i}} .$$

Without using any compensating circuit, the whole circuit of the present invention can be simplified and the manufacturing cost can be reduced.

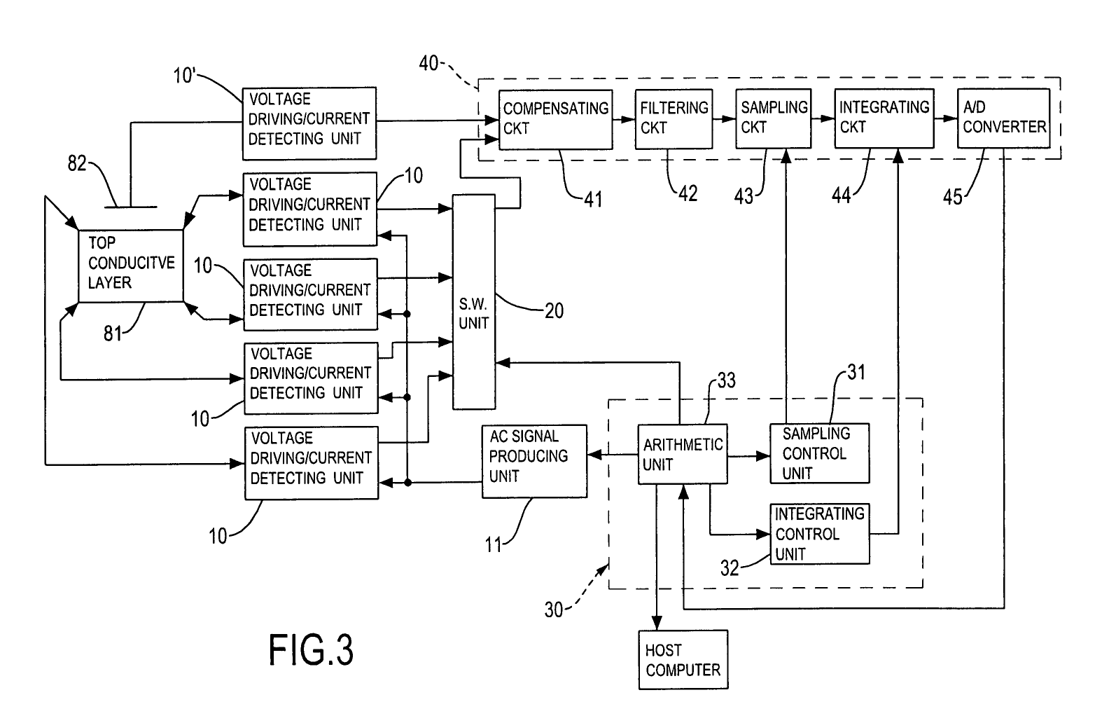

With reference to FIG. 3, a bottom conductive layer (82) of the capacitive touch panel connects to an auxiliary voltage driving/current detecting unit (10′). The signal processing unit (40) further comprises a compensating circuit (41) coupled between the filtering circuit (24) and the switching unit (20). The output of the voltage driving/current detecting unit (10′) is connected to the compensating circuit (41). The second embodiment

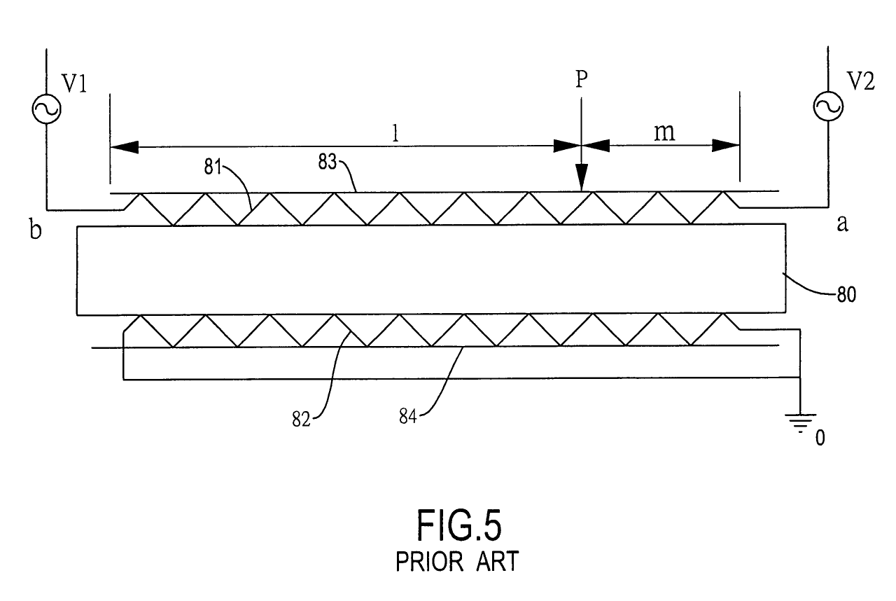

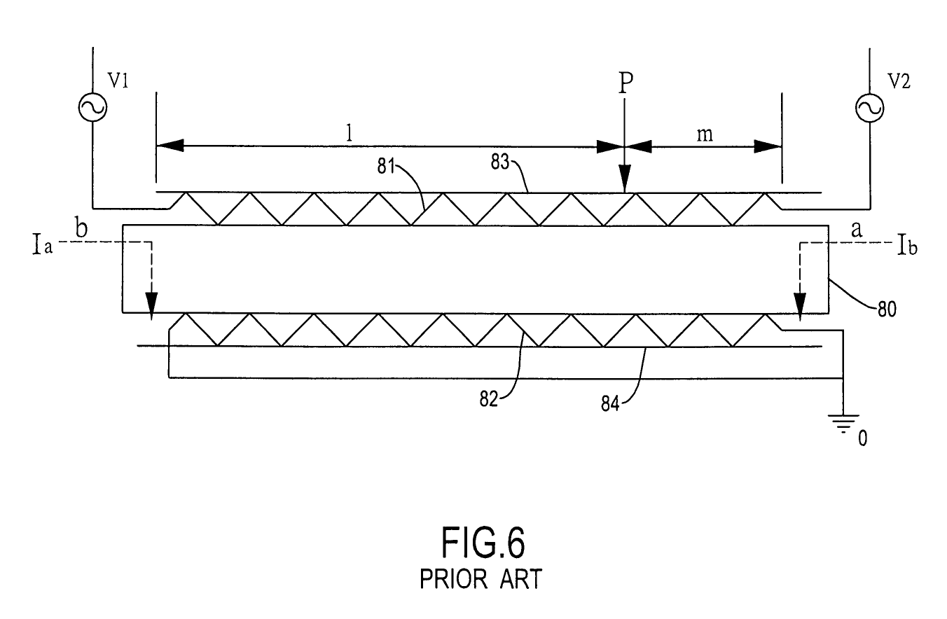

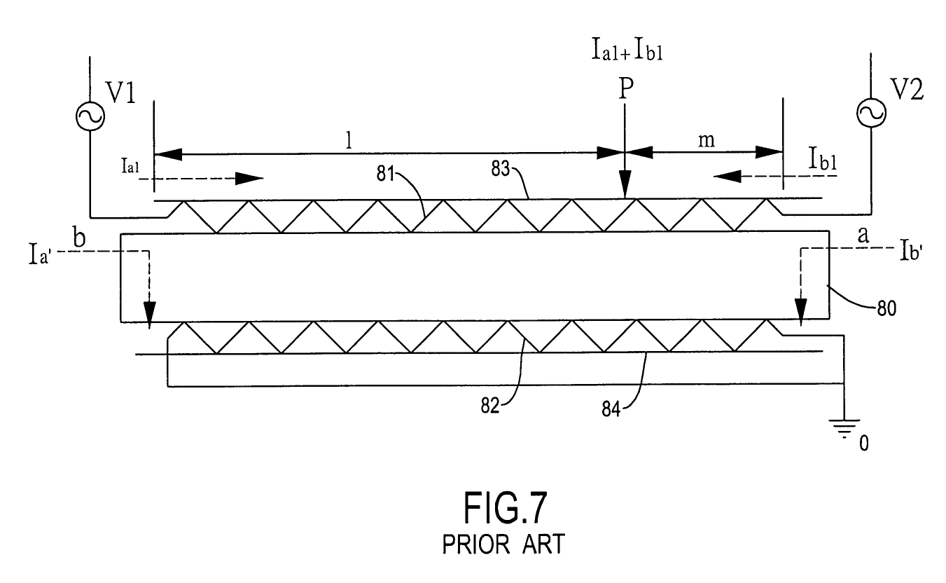

With reference to FIG. 5, because the top conductive layer (81) and the bottom conductive layer (82) are made of conductive material, a lossy capacitor is formed between the two conductive layers (81)(82). Therefore, the AC signal input to the top conductive layer (81) can be conducted to the ground through the lossy capacitor. In other words, even the user does not press the touch panel, the touch panel still has electrical currents flowing to the ground. With reference to FIG. 6, the AC signal is input to terminals a and b of the top conductive layer (81). Before been touched, the touch panel already has electrical currents Ia and Ib flowing from the terminals a and b to the ground through the bottom conductive layer (82). When any user presses the touch panel at point P as shown in FIG. 7, the current variations at all corners of the top conductive layer (81) can be detected because human body absorbs a partial current (Ia1+Ib1) while another partial current (Ias, Ibs) flows to ground through the bottom conductive layer (82).

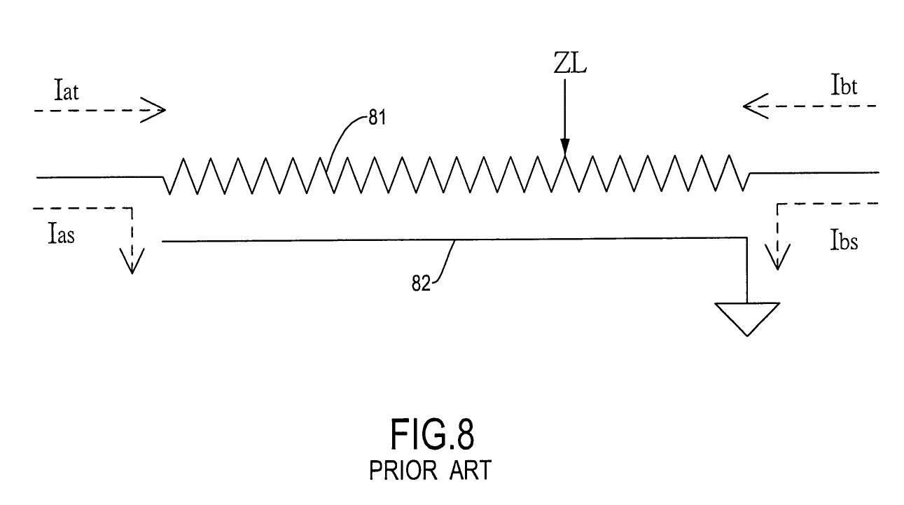

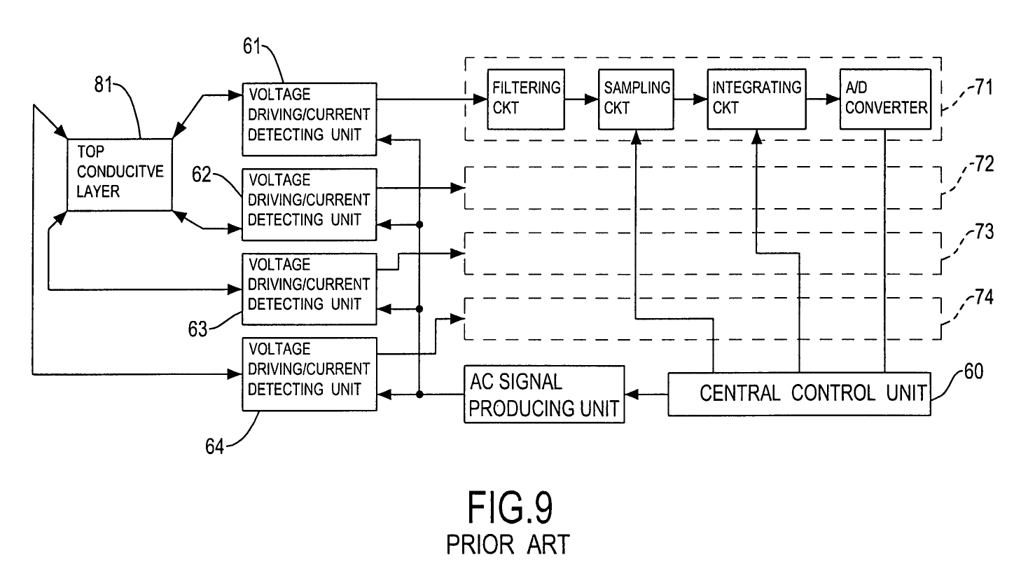

With reference to FIG. 8, if the voltage of the AC signal input to the touch panel is V=Vₒ sin(wt), the detected current values at terminals a and b are respectively expressed as

I_{A}=Ias+Iat=Ias₀ sin(wt+φ 1)+Ias₀ sin(wt+φ 2)

I_{B}=Ibs+Ibt=Ibs₀ sin(wt+φ 1)+Ibs₀ sin(wt+φ 2).

At the terminals a and b, a phase difference (φ 1, φ 2) exist between the currents and the voltages. When any conductive object contacts the touch panel at point P, the voltage potential at the point P immediately has a change. Accordingly, the electric field and current distribution over the top conductive layer (81) also change. Changes of the current values and phases can be detected at each corner of the touch panel. If the impedance value (ZL) of the user's body is relative large, the total current absorbed by human body can be regarded as a summation of all current variations at four corners of the top conductive layer (81). If the impedance value (ZL) is relative small, a partial current will flow to ground. Thus the total current absorbed by human body can not be regarded as the summation of all current variations. In the situation that the impedance value (ZL) is relative small, the compensating circuit (41) is used to compensate the coordinate calculating errors resulting from the impedance values of different operators.

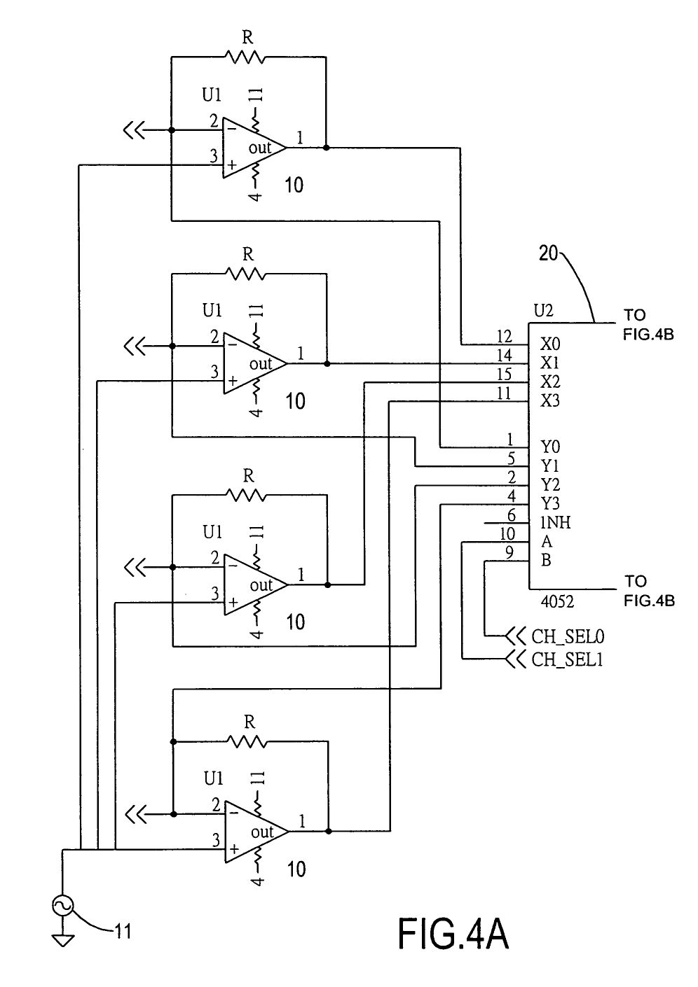

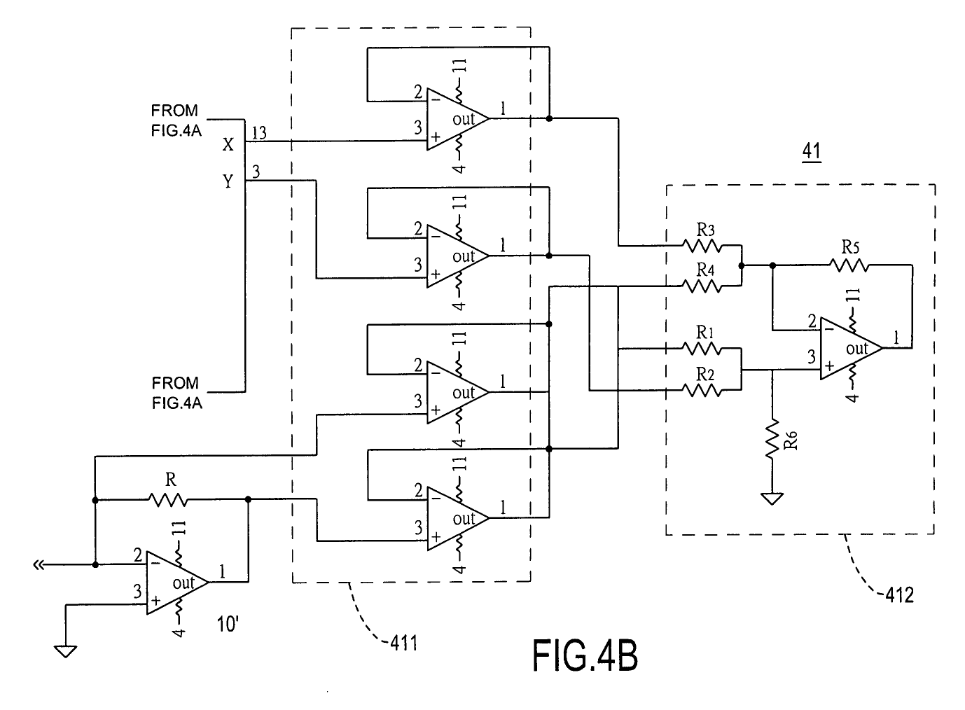

With reference to FIGS. 4A-4B, the compensating circuit (41) comprises a buffer (411) and a subtracter (412) with four input terminals. Through the buffer (411), two input terminals of the subtracter (412) are connected to the output terminals (X, Y) of the switching unit (20), and the other two input terminals are connected to the auxiliary voltage driving/current detecting unit (10′).

The auxiliary voltage driving/current detecting unit (10′) is also composed of an operational amplifier with a positive and a negative input terminal. However, the positive input terminal is connected to a DC ground, not to the AC signal producing unit (11). The negative input terminal connects to the output terminal of the operational amplifier through a resistor (R′) and is to be connected to the bottom conductive layer (82). The resistor (R′) is used to detect the current values at the corners of the bottom conductive layer (82).

Since the touch panel is mounted on either an LCD display or a CRT display, the DC ground is used in the embodiment to avoid any current interference on the bottom conductive layer (82) resulting from the display devices.

With the scanning operations of the switching unit (20), the voltage driving/current detecting units (10) sequentially transmit the detected current values at the corners of the top conductive layer (81) to the compensating circuit (41) through the switching unit (20). At the same time, the auxiliary voltage driving/current detecting unit (10′) outputs a detected current value of the bottom conductive layer (82) to the compensating circuit (41) for the purpose of compensation. Because the amount of the current flowing to the bottom conductive layer (82) is a summation of all current variations of the top conductive layer (81), the compensating circuit subtracts a quarter of the current that flows to the bottom conductive layer (82) from the detected current value at each corner of the top conductive layer (81).

The compensated signal is processed by the filtering circuit (42), the sampling circuit (43), the integrating amplifier (44) and the AID converting circuit (45). The output digital data from the A/D converting circuit (45) are transmitted to the central control unit (30) eventually to calculate coordinate of the pressed point on the touch panel.

In the scanning control device of the present invention, the current signals detected by all voltage driving/current detecting units are sequentially transmitted to a signal processing unit under the control of a switching unit and input to a central control unit for coordinate calculation. Because all the detected current signals are processed by the same signal processing unit, calculation errors resulting from separate and different signal processing units are solved. Further, the manufacturing cost for the scanning control device can be reduced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A scanning control device for capacitive touch panel that has a top conductive layer and a bottom conductive layer, the scanning control device comprising:
an alternate current (AC) signal producing unit to generate an AC signal with a constant voltage amplitude;
multiple voltage driving/current detecting units respectively connected to corners of the top conductive layer to provide the AC signal to the corners, and respectively detecting a current value at each corner;
a switching unit connected to the multiple voltage driving/current detecting units to sequentially output the current values of the multiple voltage driving/current detecting units;
a signal processing unit connected to the switching unit to receive and process the current values output from the switching unit; and
a central control unit connected to the AC signal producing unit, the switching unit and the signal processing unit to receive output data of the signal processing unit and calculate coordinate of a pressed point on the touch panel based on the data.

2. The scanning control device for capacitive touch panel as claimed in claim 1, wherein the switching unit is a multiplexer with a set of output terminals and multiple input terminals connected to the voltage driving/current detecting units, and is controlled by the central control unit.

3. The scanning control device for capacitive touch panel as claimed in claim 2, wherein the signal processing unit comprises a filtering circuit, a sampling circuit, an integrating amplifier and an analog to digital (AID) converting circuit, and the central control unit comprises:
a sampling control unit connected to the sampling circuit to control sampling frequency and time;
an integrating control circuit connected to the integrating amplifier to control a gain of the integrating amplifier;
an arithmetic circuit connected to the sampling control circuit, the integrating control circuit, the AC signal producing unit and the A/D converting circuit to control their operations, the arithmetic circuit further adapted to connect to a host.

4. The scanning control device for capacitive touch panel as claimed in claim 3, each voltage driving/current detecting unit comprising an operational amplifier with a positive input terminal, a negative input terminal and an output terminals, the positive input terminal connected to the AC signal producing unit, the negative input terminal connected to the output terminal through a feedback resistor and to be connected to the top conductive layer, wherein the current values of the top conductive layer are measured using the feedback resistors.

5. The scanning control device for capacitive touch panel as claimed in claim 3 further comprising:
an auxiliary voltage driving/current detecting circuit connected to the bottom conductive layer of the capacitive touch panel; and
the signal processing unit further comprising a compensating circuit with input terminals connected to the auxiliary voltage driving/current detecting circuit and the switching unit, wherein the compensating circuit has output terminals connected to the filtering circuit.

6. The scanning control device for capacitive touch panel as claimed in claim 5, the auxiliary voltage driving/current detecting circuit comprising an operational amplifier with a positive input terminal, a negative input terminal and an output terminals, the negative input terminal connected to the output terminal through a feedback resistor, the output terminal connected to the compensating circuit.

7. The scanning control device for capacitive touch panel as claimed in claim 6, the positive input terminal of the operational amplifier of the auxiliary voltage driving/current detecting circuit connected to a DC ground.

8. The scanning control device for capacitive touch panel as claimed in claim 5, the compensating circuit comprising a buffer and a subtracter.
